(19) United States
(12) Patent Application Publication
(10) Pub. No.: US 2006/0185585 A1
(43) Pub. Date: Aug. 24, 2006

(54) Ski and snowboard waxing apparatus and method of use

(76) Inventor: Salahedin B. McLean, Orem, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/336,647

(22) Filed: Jan. 20, 2006

Related U.S. Application Data
(60) Provisional application No. 60/651,150, filed on Feb. 9, 2005.

(51) Int. Cl. B05C 11/02

(52) U.S. Cl. 118/101; 118/202; 118/271

(57) ABSTRACT

An improved ski and snowboard waxing apparatus and method of use allows a user to more easily and quickly apply a uniform layer of wax to a ski, snowboard, or the like. The wax layer may be applied without the use of specialized tools. Additionally, the wax may be applied and cooled prior to removal of the backing layer, and may be applied to the ski in zones.

### RELATED APPLICATIONS

The present application claims the benefit of U.S. Provisional Application No. 60/651,150, filed Feb. 9, 2005.

### BACKGROUND OF THE INVENTION

1. The Field of the Invention

The present invention relates to a method and apparatus for waxing skis, snowboards, and the like. More specifically, the present invention relates to a simpler and more convenient method of applying wax.

2. State of the Art

Wax is commonly used to improve the surface qualities of skis, snowboards, and the like. Specifically, wax is used on the bottom surface of a ski or snowboard to increase performance. Wax helps to reduce the friction between the ski or snowboard and the snow, making the ski faster. In some situations, special waxes may also be used to allow a ski to grip the snow better, such as may be applied in the grip zone of cross country skis. Accordingly, various different types of waxes and related products are applied to the bottom surface of snowboards and skis to allow the user to customize the interaction between the snowboard or ski and the snow.

Waxes are conventionally applied by ironing the wax onto the ski. Specialized irons are used to melt a small block of ski wax while the user lets the wax drip onto the ski or snowboard. The iron is then used to spread the wax across the surface of the snowboard or ski. Great care must be taken to ensure that the wax is spread evenly across the surface, that the correct thickness of wax is applied, and that the surface of the wax is uniform. Typically, a vise must be used to hold the ski or snowboard horizontal, and specialized tools such as irons, scrapers, etc. are needed to complete the process. Accordingly, waxing is somewhat difficult and requires practice and proper tools to do correctly.

Having skis or snowboards waxed professionally, however, is relatively expensive. The cost of professional waxing dissuades many individuals from periodically waxing their skis or snowboards as should be done for proper equipment maintenance. Many individuals would desire to wax their skis or snowboard themselves, but do not do so because of the difficulty of the process or the equipment necessary. Additionally, even professional ski technicians would prefer a method which is easier and creates less mess.

There is thus a need for an improved method and apparatus for waxing skis, snowboards, and the like which is easier to use than the conventional waxing process. There is also a need for a waxing apparatus and method which allows a user to quickly and easily spread the proper quantity of wax, uniformly distribute the wax, and achieve a uniform surface finish. There is also a need for a method of waxing skis and snowboards which does not require specialized tools, or which makes the waxing process easier.

### SUMMARY OF THE INVENTION

It is an object of the present invention to provide an improved ski and snowboard waxing apparatus and method of use. It is a further object of the present invention to provide a waxing apparatus and method of use which provides a wax job of improved quality and/or is easier to apply.

According to one aspect of the present invention, a predetermined amount of a snowboard and ski wax may be provided. A snowboard and ski wax may be provided in a preformed layer of appropriate thickness and attached to an application backing layer.

According to another aspect of the present invention, a method of waxing may be provided wherein specialized tools are not necessary. An application backing layer may be provided with a layer of wax of the appropriate thickness applied to one side of the backing layer, allowing a user to use a conventional iron to heat the backing layer and wax and deposit the wax on the ski or snowboard. As the iron need not contact the wax, a dedicated iron is not necessary. As the wax may be deposited in a layer of predetermined thickness, scrapers and other tools may not be necessary, or may be used less frequently.

According to another aspect of the present invention, a method of applying wax to skis or snowboards is provided which is easier and which yields more consistent results than conventional methods. An application backing layer having a wax layer on one side is used to apply wax, allowing an individual to apply wax quicker and easier than conventional methods. Additionally, consistent results are achieved as a more uniform layer of wax is deposited onto the ski or snowboard.

### BRIEF DESCRIPTION OF THE DRAWINGS

Various embodiments of the present invention are shown and described in reference to the numbered drawings wherein:

FIG. 1A shows a perspective view of ski waxing according to the prior art;

FIG. 1B shows a side view of a waxing apparatus according to the prior art;

FIG. 1C shows a side view of another prior art waxing apparatus;

FIG. 2A shows a side view of a waxing apparatus according to the present invention;

FIG. 2B shows another side view of a waxing apparatus according to the present invention;

FIG. 2C shows another side view of a waxing apparatus according to the present invention;

FIG. 3 shows a top view of waxing apparatus according to the present invention;

FIG. 4 shows a side view of ski waxing according to the present invention;

FIG. 5 shows a top view of another waxing apparatus according to the present invention; and

FIG. 6 shows a side view of yet another waxing apparatus according to the present invention.

It will be appreciated that the drawings are illustrative and not limiting of the scope of the invention which is defined by the appended claims. The various embodiments shown accomplish various aspects and objects of the invention.

### DETAILED DESCRIPTION

The drawings will now be discussed in reference to the numerals provided therein so as to enable one skilled in the art to practice the present invention. The drawings and descriptions are exemplary of various aspects of the invention and are not intended to narrow the scope of the appended claims.

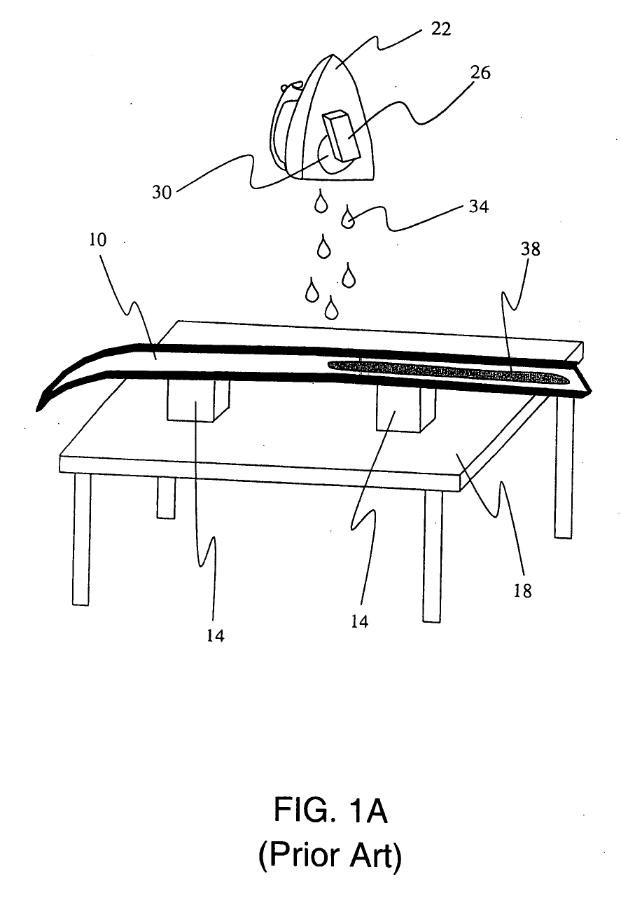

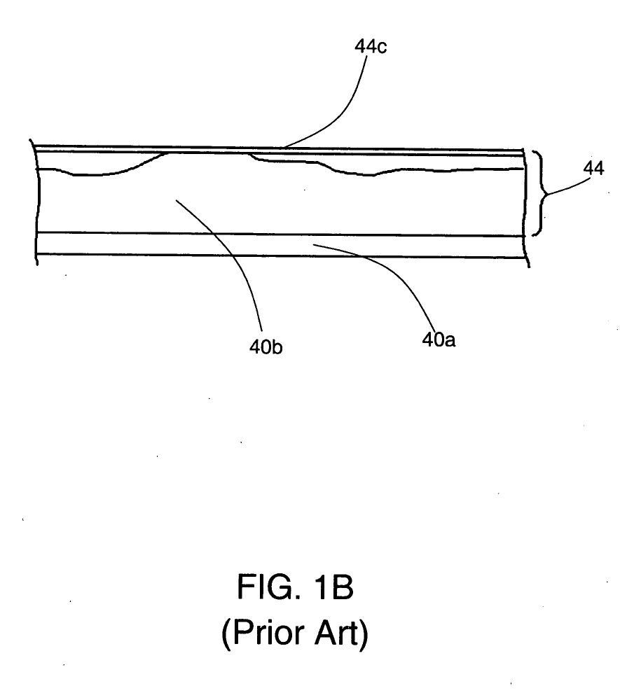

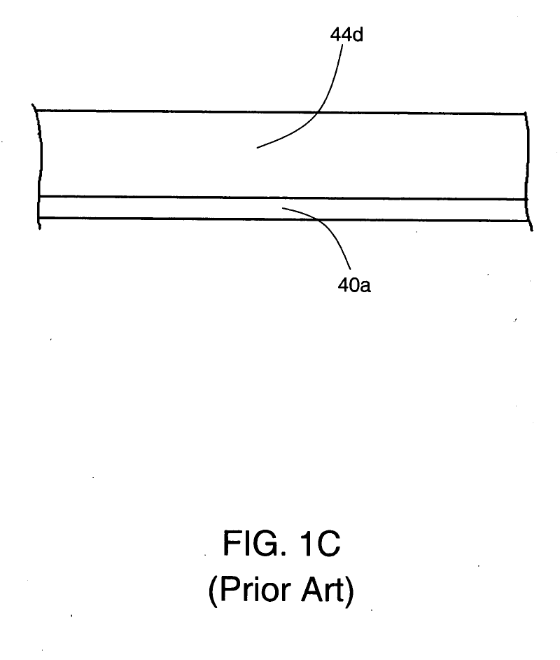

Turning to FIG. 1A a perspective view of applying ski wax according to the prior art is shown. The ski 10 must be placed in clamps or vises 14 to thereby firmly attach the ski 10 to a table 18 or other support surface. An iron 22 is used to melt a portion of a block of ski wax 26, spreading melted wax 30 onto the surface of the iron 22. The melted wax 30 runs down the surface of the iron 22 and drips 34 off of the tip of the iron 22. A trail of wax 38 is thus formed on the ski 10. The iron 22 is then used to spread the wax 38 onto the ski 10. Scrapers and other tools are then used to remove excess wax and create the desired surface in the wax.

It will be appreciated that a proper clamping devise 14 is desirable to keep the ski or snowboard level and stationary while applying wax. Additionally, the clamping device 14 should be sufficiently rigid to withstand the various steps of melting, scraping, surfacing the wax, etc. Ski stands are relatively expensive, dissuading many individuals from waxing their own skis. Additionally, the iron 22 is contaminated with the wax and thereafter suitable only for waxing skis, requiring an individual to purchase a dedicated iron for waxing skis. The process is also somewhat difficult and time consuming, requiring practice and patience to achieve good results.

Turning now to FIG. 1B, a side view of a prior art waxing apparatus is shown. Some work has been done to provide a wax on an applicator sheet, which may then be transferred to a desired surface. Prior attempts have resulted in a device which has a layer of wax 40a applied to a layer of paper 44. See e.g. U.S. Pat. No. 4,308,633. The wax 40a is melted and applied to the paper layer 44, resulting in both wax which has soaked into the paper 40b and a surface layer of wax 40a on the paper. A barrier layer 44c has been applied to the back of the paper 44 to prevent contamination of an iron or heating device which is used to heat the wax and transfer the wax to a surface. The barrier layer 44c is a material which is impervious to wax, and helps prevent wax from contaminating the iron used to apply the wax. The use of the apparatus results in a significant amount of wax being wasted because it has soaked into the paper, and because wax may remain on the paper instead of transferring to the desired surface. Because the wax readily soaks into the paper, removal of the paper may also cause removal of wax from the surface to which wax is applied. Thus, it may be difficult to control the consistency of application, thickness of application, and the quality of the wax surface created.

A further attempt known in the prior art to make a wax application sheet shown in FIG. 1C replaces the paper with a plastic layer. See e.g. U.S. Pat. No. 5,534,061. The plastic 44d prevents wax 40a from soaking through the plastic layer, as occurs with paper. The plastic layer 44d, may still retain some wax when heated instead of transferring all of the wax to the desired surface. Retaining wax on the plastic layer wastes wax, and may result in a deposited wax layer which is not smooth or which is inconsistent. The plastic layer may also be melted as a user heats the apparatus to melt the wax and transfer the wax to a surface. The application of too much heat, by an iron which is too hot of held in place too long, may melt the plastic. Melting the plastic may ruin the wax surface of the ski or snowboard, or worse, may damage the ski or snowboard. Additionally, the plastic layer 44d may be more flexible than a paper layer of corresponding thickness and may thus be more difficult to use, as a thin plastic layer may be too flexible for easy handling. Plastics also tend to shrink or otherwise become dimensionally unstable when heated. Such disadvantages may make a wax applicator difficult to use, and may result in a wax surface which is less uniform than desired.

It is important to achieve a high efficiency of transfer of wax from the applicator sheet to the desired surface for multiple reasons. The complete transfer of wax results in a more consistent layer of wax on the desired surface, and a consistent surface texture. Where wax is applied to skis and the like, it is not desirable to have a layer of wax which is too thick or too thin, or which has an uneven surface texture. The complete transfer of wax also reduces the waste of the wax, which is relatively expensive. Additionally, a product which completely transfers wax to the desired surface and which easily releases the wax will typically be easier to use than a product which does not efficiently transfer the wax to the surface. It is desirable to achieve a consistent and efficient transfer of wax to the desired surface, and to achieve a product which is easy to use and which does not create unnecessary mess.

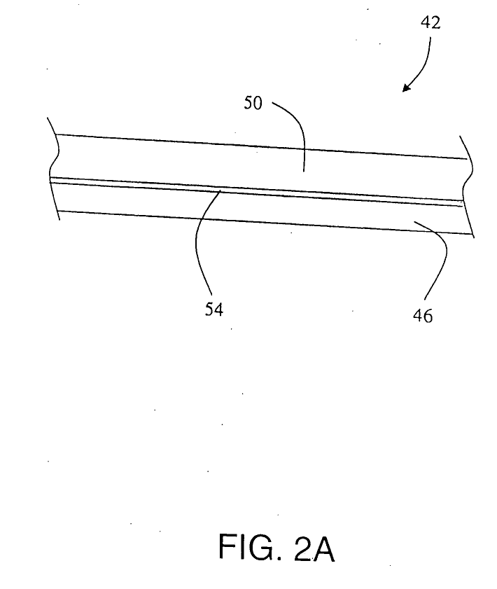

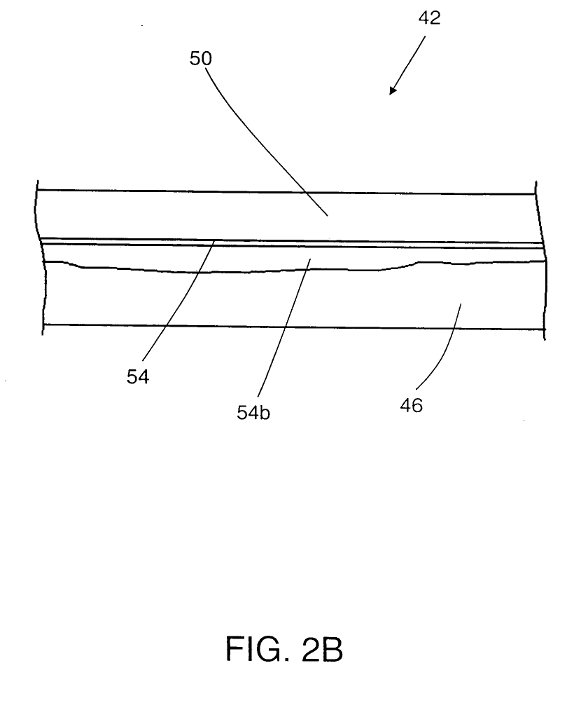

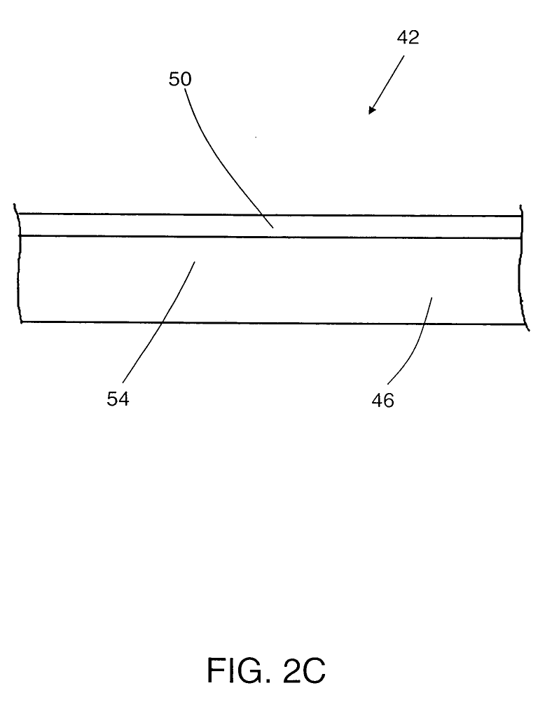

Turning to FIG. 2A, a side view of a waxing apparatus according to the present invention is shown. In discussing the present invention, the term “ski” will be used to represent winter sports equipment more broadly, including skis, snowboards, and other devices which may receive the same wax treatment such as sled runners, snowmobile skis, surfboards, water skis, etc. Thus, in the claims, the term ski is used for clarity of language but is specifically intended to include skis, snowboards, and other similar devices. The waxing apparatus, indicated generally at 42, has been formed from an application backing layer 46 and a layer of wax 50. The application backing layer 46 may be formed from a variety of different materials. Notably, thin sheets of metal, plastic, paper, etc. are suitable for use as an application backing layer 46. According to one embodiment, the backing layer is formed from paper. It is desirable to provide a backing layer 46 which is sufficiently flexible to conveniently package, such as by rolling the waxing apparatus and placing it in a box or providing it in a large roll. The backing layer 46 should also be sufficiently rigid to create an apparatus 42 which is easy to use.

A typical example of a backing material 46 is the 50 lb. 3.1 mil. thick super calendered kraft, release liner base paper as provided by Penta-tech Coated Products, L.L.C. of Bangor, Me. USA. Such a backing material includes a release layer. Those skilled in the art will appreciate, in light of the present disclosure, that many papers or many other materials in combination with a desirable release agent/release layer are available.

Although not necessary, the backing layer 46 may have additives therein to change the physical properties. For example, cornstarch may be used as part of the backing layer. Such additives may increase the stiffness of the backing layer or may help prevent the wax (applied to the release layer) from sticking to the back side of the backing layer if the waxing apparatus is stacked or rolled for storage. Although discussed as a separate layer, the release layer may even be formed as part of the backing layer. For example, if a porous substance such as paper is used as a backing layer, a release agent may be used which soaks into the backing layer when applied. Additionally, a release agent may be mixed into the backing layer, such as paper, when the backing layer is being formed such that the surface properties of the backing layer are modified to inhibit the adhesion of the wax to the backing layer and promote the complete transfer of the wax to the desired surface.

Also of importance is the ability of the waxing apparatus 42 to release the wax 50 onto the ski or snowboard. The apparatus 42 preferably does not have a stronger adhesion to the wax 50 than the wax 50 has to the ski or snowboard, and more preferably has very little adhesion to wax, promoting complete release of the wax to the surface. As has been discussed above, the complete or near complete transfer of wax to the ski or snowboard is desirable for many reasons, such as eliminating waste, providing consistent results, and providing ease of use. Accordingly, in a more preferred embodiment, the backing layer 46 has a release layer 54 attached thereto or formed thereon. The release layer is typically a thin layer of material applied to a surface of the backing layer to reduce the adhesion of the backing layer to the wax layer 50. Release layers are known and used to allow an object with a very high adhesion to a surface, such as tape or stickers, to be removably affixed to a backing prior to use. The release layer may be formed from a variety of materials, such as a vinyl acrylic emulsion or an anionic modified vinyl acrylic emulsion, a silicone substance, or any other desired release layer. It will be appreciated that the paper may contain additives to enhance properties of the paper, such as stiffness, or to promote the adhesion of the release layer. It will also be appreciated that the release layer may be formed as a surface layer, may soak into the backing layer somewhat, or may penetrate substantially into the backing layer. Thus, it is not important to what extent a release layer may have penetrated into the backing layer, but is important that such a release layer modify the surface characteristics of the backing layer to promote complete transfer of the wax. In the context of the present waxing apparatus, the release layer is advantageous as it promotes transfer of the wax to the ski or snowboard, but disadvantageous as it discourages the formation of a wax layer on the release layer and makes formation of the waxing apparatus 42 extremely difficult.

The wax 50 is a ski wax as is provided by many different ski wax manufacturers, such as Roger A. Reed, Inc., supplier of Industrial and Specialty Waxes, Reading, Mass. USA, or similar companies such as Dr. D's race wax or One Ball Jay ski wax. It will be appreciated that any of the different melting temperatures and types of wax may be used. The wax layer 50 has been formed by melting and spreading, spraying, or otherwise forming the wax onto the backing layer 46. It will be appreciated that the release layer is intended to inhibit adhesion of the wax to the waxing apparatus 42 so as to allow for complete transfer of the wax to a ski or snowboard. As such, the use of a release layer inhibits deposition of the wax onto the apparatus 42. It has been found that successful application of the wax to the release layer may be accomplished by melting wax at a temperature within a few degrees of its melting temperature and carefully applying the melted wax to the release layer. As the wax is not attracted to the release layer as it is to paper or some plastics, the wax does not wet-out to the release layer and instead would simply bead up or roll off of the surface. Careful application of molten wax within a few degrees of its melting temperature aids in forming an even layer of wax. The wax layer 50 should ideally be uniformly applied to the backing layer 46 and applied in a predetermined thickness. It will be appreciated, however, that the wax layer 50 may be applied such that one part of the ski will receive a thicker layer of wax than a different part of the ski, as may be desired. Advantageously, the predetermined thickness of the wax layer determines how much wax is deposited onto the ski. Accordingly, a consistent desired amount of wax may be applied to the ski or snowboard.

The release layer 54 is thus advantageous as it promotes complete or near complete transfer of wax to a surface. The release lay promotes the transfer of wax to the surface both when the wax is melted and when solidified. Thus, the apparatus 42 may be removed from a ski or snowboard after melting the wax but before the wax hardens, leaving nearly all of the wax on the ski or snowboard. Alternatively, the apparatus 42 may be left on the ski or snowboard after melting the wax, allowing the wax to cool. The release layer 54 promotes the complete transfer of wax to the surface even after the wax has hardened. Thus, the apparatus 42 may be left on the ski or snowboard as a protective layer without fear of ruining the wax layer during removal of the apparatus.

Turning now to FIG. 2B, another waxing apparatus according to the present invention is shown. The apparatus 42 is similar to that of FIG. 2, having a backing layer 46, release layer 54, and wax layer 50, and functions in a similar manner. FIG. 2B illustrates that some release agents, when applied as a surface coating to form a release layer 54, will soak into 54b a porous lacking layer 46.

Turning now to FIG. 2C, another waxing apparatus according to the present invention is shown. The apparatus 42 is also similar to that of FIG. 2, with a backing layer 46 and wax layer 50. FIG. 2C illustrates that the backing layer 46 may comprise a release agent which has been applied to soak completely into the backing layer, making the release layer 54 and backing layer 46 indistinguishable. Alternatively, a release agent may be mixed into the backing layer 46 during formation of the backing layer such that the release layer 54 and backing layer are indistinguishable. Still, a compound may be chosen which serves both as a backing layer 46 and a release layer 54. Such a compound need have suitable structural integrity and strength to allow the wax layer 50 to be applied to a ski, and need have suitable chemical properties to allow for efficient transfer of the wax to the ski, as has been discussed. Thus, an anionic modified vinyl acrylic emulsion may be formed in a layer of sufficient thickness to allow use as both a release layer and backing layer.

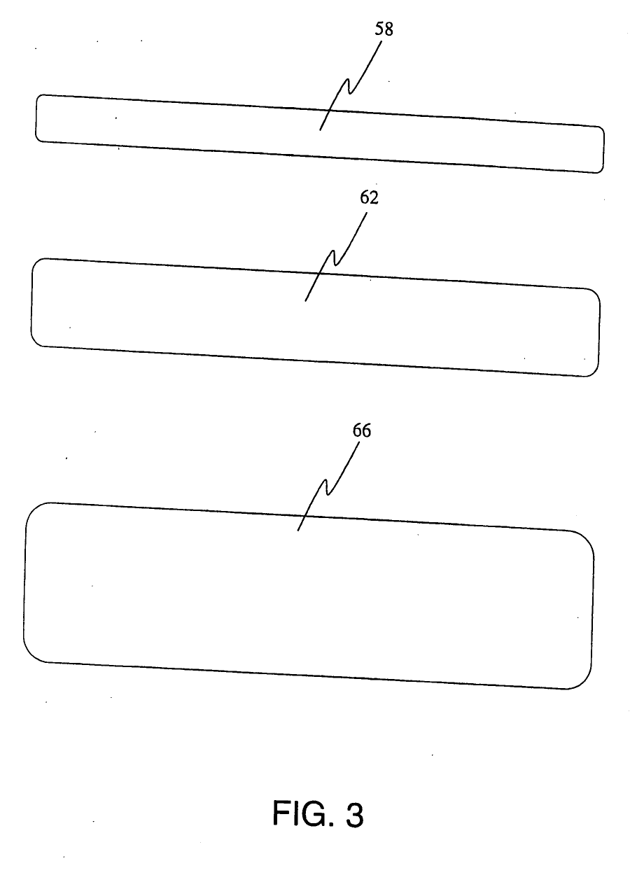

Turning now to FIG. 3, a top view is shown of waxing apparatus according to the present invention. The waxing apparatus are formed of a sheet consisting of the backing layer, release layer, and wax layer of FIG. 2. As shown, a waxing apparatus 58, 62, 66 may be formed so as to wax a single ski 58, a pair of skis 62, a snowboard 66, or in any other particular shape as is desired.

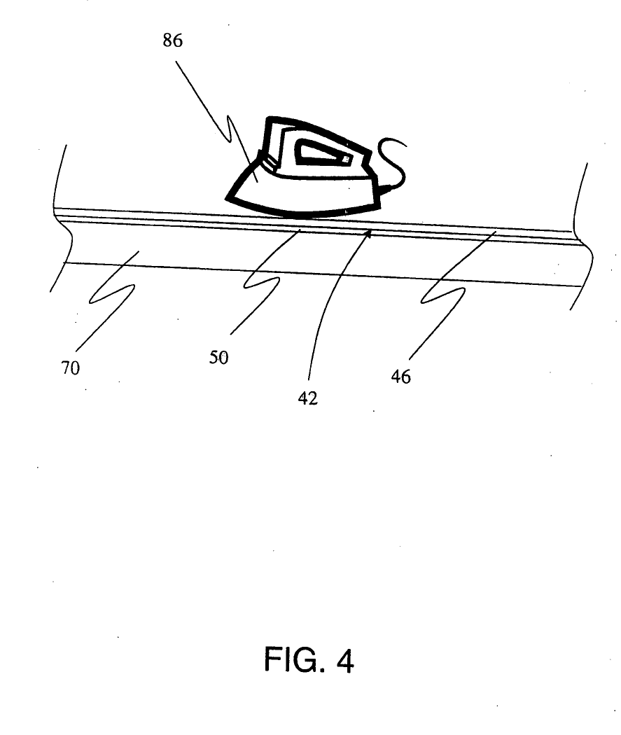

Turning now to FIG. 4 a side view of a waxing apparatus being applied to a ski is shown. The ski 70 has been placed with the bottom surface up, and a waxing apparatus, indicated at 74 has been placed on top of the ski such that the wax layer 78 is in contact with the ski 70 and the backing layer 82 faces away from the ski. An iron 86 is used to press the waxing apparatus 74 against the ski 70 and to heat the waxing apparatus 74 sufficiently to melt the wax layer 78 and thereby bond the wax layer to the ski 70. The iron 86 is then removed from contact with the waxing apparatus 74. The backing layer may be then removed from the ski 70, leaving behind the layer of wax 78. Alternatively, the wax layer 78 may first be allowed to cool and harden before removing the backing layer 82. Those skilled in the art will appreciate that allowing the wax to harden on an applicator without a release layer would tend to rough finish to the wax when the applicator is removed, and may require additional smoothing with the iron.

It will thus be appreciated that it is desirable to have a backing layer 82 which is flexible such that it will remain flat when placed on top of the ski or snowboard and such that the backing layer 82 may be easily removed from the ski or snowboard. Additionally, it will be appreciated that a backing material 82 which has a release layer may be advantageous in allowing most or all of the wax 78 to remain on the ski or snowboard, and not soak into the backing layer 82 or be removed with the backing layer 82. Thus, a paper backing layer with a release layer may be the most preferable material for the backing layer, although other materials with a release layer will also work well.

It will also be appreciated from FIG. 2 through FIG. 4 that specialized and dedicated tools may not be necessary for applying ski or snowboard wax according to the present invention. Since a more uniform wax layer is formed on the backing layer, it may not be necessary to spread the wax or scrape off excess wax. Of course, thicker layers of wax may be applied and scraped and worked conventionally if desired. Additionally, a dedicated or specialized iron is not necessary as the backing layer may effectively prevent wax from contacting the iron. Special vises or clamps also may not be necessary, as the waxing process no longer involves extensive spreading or scraping of the wax and the forces associated therewith.

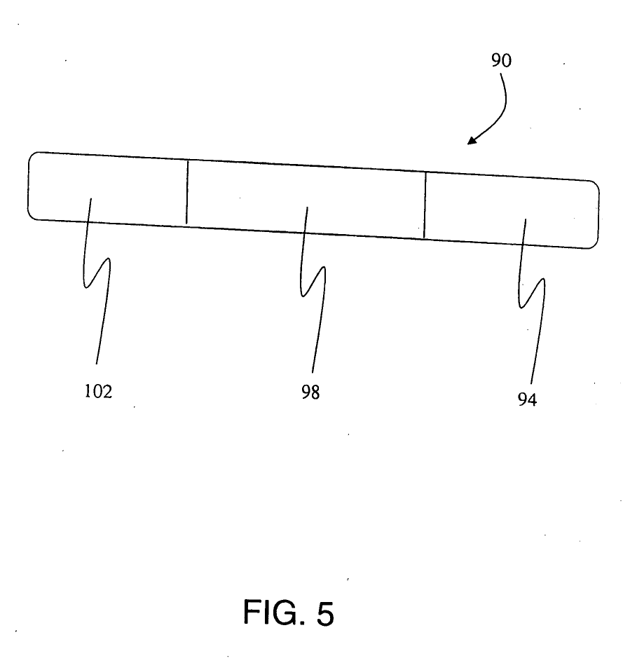

Turning now to FIG. 5, a top view of another waxing apparatus is shown. The waxing apparatus, indicated generally at 90, has been formed with a wax layer and a backing layer as previously described. The waxing apparatus 90 has been formed with zones of different types of wax, as may be desired for some applications. For example, cross country skis are often waxed using different types of wax in the different areas of the skis. Thus, a glide wax may be used on the front and back areas of the ski and a grip wax may be used on the middle part of the ski. Thus, a waxing apparatus 90 may be formed with a zone 94 of glide wax for the front of the ski, a zone 98 of grip wax for the grip section of the ski, and a zone 102 of glide wax for the rear portion of the ski. Many different types of waxes may thus be combined into one waxing apparatus to provide the desired wax layers on the ski. Thus, a ski may be easily waxed in one step which uses multiple waxes and gives the result of a more complicated wax job. It will also be appreciated that if different zones of wax are used on a single waxing apparatus, different colors may be used on the backing layer to allow a user to easily identify the zones of wax and properly apply the wax. Additionally, it will be appreciated that different sizes of waxing apparatus may be made such that the different zones of wax are in the proper location for different sizes of skis. In all, even a person with modest experience can apply multiple waxes to zones in a manner previously requiring considerable skill.

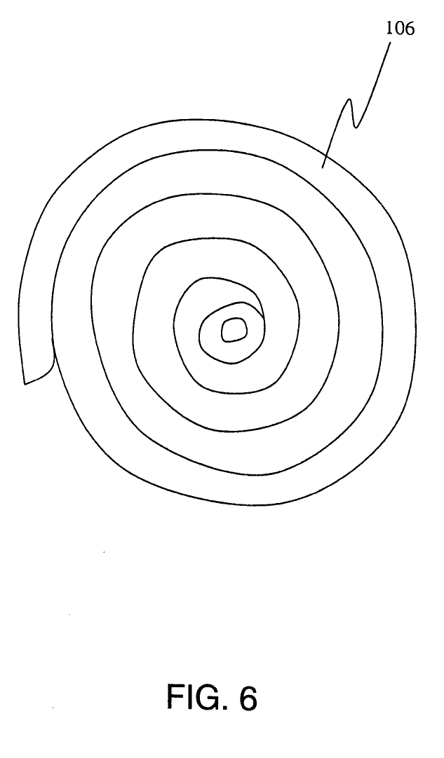

Turning now to FIG. 6, a side view of a waxing apparatus according to the present invention is shown. A waxing apparatus according to the present invention may be formed as a large bulk roll 106 of the waxing apparatus, allowing a user to cut off precisely the length necessary for a particular job. Different widths may be made for different widths of skis or snowboards, etc. Thus, a ski or snowboard tuning shop may cut off a particular length of the waxing apparatus for use in waxing the ski or snowboard. Additionally, various rolls of the waxing apparatus may be provided which use a different wax, and which use a backing layer which is colored or otherwise marked to indicate the different waxes. Thus, the type of wax may be chosen according to the ski conditions. Additionally, pieces or each roll may be cut and placed adjacent each other on the ski and then melted with an iron to provide a wax job having different waxes on different parts of the ski or snowboard as may be desired. Even a more complicated wax job using different waxes on different parts of the ski may be quickly and easily accomplished with consistent results by using the present invention.

There is thus disclosed an improved ski and snowboard waxing apparatus and method of use. It will be appreciated that numerous modifications may be made to the present invention without departing from the scope of the invention. The preceding examples are illustrative of the invention, and do not define the scope of the invention or limit the appended claims.

What is claimed is:

1. A ski wax application apparatus comprising:
a backing layer;
a release layer disposed on a side of the backing layer; and
a layer of ski wax disposed on the release layer; and
wherein the apparatus is configured for placement against a ski such that the wax is adjacent the ski, and wherein the apparatus is configured for heating to thereby adhere the wax to the ski.

2. The apparatus of claim 1, wherein the backing layer is paper.

3. The apparatus of claim 1, wherein the backing layer is plastic.

4. The apparatus of claim 1, wherein the release layer is an anionic modified vinyl acrylic emulsion.

5. The apparatus of claim 1, wherein the apparatus further comprises a first section and a second section, and wherein the wax which is disposed on the first section is different than the wax which is disposed on the second section.

6. The apparatus of claim 5, further comprising a third section having a wax different from the second section.

7. The apparatus of claim 1, wherein the backing layer and release layer are configured for removal from the ski or snowboard after the wax has been melted to thereby deposit a wax layer on the ski.

8. A method of waxing a ski, the method comprising:
selecting a waxing apparatus, the waxing apparatus comprising a backing layer, a release layer disposed on a side of the backing layer, and a wax layer affixed to the release layer;
placing the waxing apparatus on the bottom of a ski such that the wax layer is adjacent the ski;
heating the waxing apparatus to thereby adhere the wax to the ski; and
removing the backing layer to thereby remove the backing layer from the wax layer, thereby depositing the wax layer on the ski.

9. The method of claim 8, wherein the method further comprises heating the waxing apparatus with an iron.

10. The method of claim 8, wherein the method further comprises selecting a waxing apparatus having a wax layer comprising a first zone of a first wax and a second zone of a second wax.

11. The method of claim 8, wherein the method further comprises selecting a second waxing apparatus comprising a backing layer and a wax layer affixed to the backing layer, and wherein the wax layer is a different wax than the wax layer of the first waxing apparatus, and wherein the method further comprises placing the first waxing apparatus on a first area of the ski and placing the second waxing apparatus on a second area of the ski.

12. The method of claim 8, wherein the method comprises allowing the wax to cool prior to removal of the backing layer and release layer.

13. The method of claim 8, wherein the method comprises removing the backing layer and release layer without substantially allowing the wax to cool.

14. An apparatus for applying wax to a surface comprising:
a backing layer;
a release layer disposed on a side of the backing layer; and
a layer of wax disposed on the release layer.

15. The apparatus of claim 14, wherein the backing layer is paper.

16. The apparatus of claim 14, wherein the backing layer is plastic.

17. The apparatus of claim 14, wherein the release layer comprises a vinyl acrylic emulsion.

18. The apparatus of claim 14, wherein the release layer comprises an anionic modified vinyl acrylic emulsion.

19. The apparatus of claim 14, wherein the wax is a ski wax.

20. An apparatus for applying wax to a ski comprising:
a backing layer, the backing layer having at lease one surface comprising a release agent; and
a layer of ski wax applied to the at least one surface.

21. The apparatus of claim 20, wherein the at least one surface comprises a release agent applied to a surface of the backing layer.

22. The apparatus of claim 21, wherein the release agent penetrates into the backing layer.

23. The apparatus of claim 21, wherein the release agent is formed integrally with the backing layer.

24. The apparatus of claim 20, wherein the apparatus is configured for placing the wax layer against a ski and heating to thereby deposit the wax layer on the ski.

25. The apparatus of claim 20, wherein the release agent comprises an anionic modified vinyl acrylic emulsion.

26. The apparatus of claim 20, wherein the release agent comprises a silicone compound.
